(19) United States
(12) Patent Application Publication
(10) Pub. No.: US 2025/0299222 A1
(43) Pub. Date: Sep. 25, 2025

(54) METHOD, APPARATUS, DEVICE, MEDIUM AND PRODUCT FOR CONTENT PRESENTATION

(71) Applicant: Beijing Youzhuju Network Technology Co., Ltd., Beijing (CN)

(72) Inventor: Li Jia, Beijing (CN)

(21) Appl. No.: 19/084,529

(22) Filed: Mar. 19, 2025

(30) Foreign Application Priority Data
Mar. 20, 2024 (CN) 202410324568.2

(51) Int. Cl. G06Q 30/0251; G06Q 30/0241

(52) U.S. Cl. CPC G06Q 30/0251; G06Q 30/0277

(57) ABSTRACT

According to embodiments of the disclosure, a method, an apparatus, a device, and a medium for content presentation are provided. The method includes: receiving, from a service provider, structured service information related to a target service; selecting, based on a content derivation rule related to the target service, at least one content style from a plurality of content styles; generating, based on the structured service information, at least one recommended content item having the at least one selected content style, respectively, each recommended content item being used to present at least a portion of the structured information; and presenting the at least one recommended content item to at least one user in a user group corresponding to the target service.

### CROSS REFERENCE

The application claims priority to Chinese Patent Application No. 202410324568.2, filed on Mar. 20, 2024, and entitled “METHOD, APPARATUS, DEVICE, MEDIUM AND PRODUCT FOR CONTENT PRESENTATION”, the entirety of which is incorporated herein by reference.

### FIELD

Example embodiments of the present disclosure generally relate to the field of computer technologies, and in particular, to a method, an apparatus, an electronic device, a computer-readable storage medium, and a computer program product for content presentation.

### BACKGROUND

The Internet provides access to a variety of resources. For example, various applications, products, audio and video contents, etc. can be accessed through the Internet. In addition, content delivery and service promotion through the Internet have become a new form of information dissemination and are widely used. Advertising systems support displaying recommended content or services to users in different advertisement display opportunities, so that users can browse and acquire corresponding services as needed. In addition, from the recommended content presented in the advertisement display opportunity, it is also possible to jump to a detailed page corresponding to the recommended content or service for further viewing more content or obtaining other interactive entry.

### SUMMARY

In a first aspect of the present disclosure, there is provided a method for content presentation. The method includes: receiving, from a service provider, structured service information related to a target service; selecting, based on a content derivation rule related to the target service, at least one content style from a plurality of content styles; generating, based on the structured service information, at least one recommended content item having the at least one selected content style, respectively, each recommended content item being used to present at least a portion of the structured information; and presenting the at least one recommended content item to at least one user in a user group corresponding to the target service.

In a second aspect of the present disclosure, there is provided an apparatus for content presentation. The apparatus includes: an information receiving module configured to receive, from a service provider, structured service information related to a target service; a style selecting module configured to select, based on a content derivation rule related to the target service, at least one content style from a plurality of content styles; a content generating module configured to generate, based on the structured service information, at least one recommended content item having the at least one selected content style, respectively, each recommended content item being used to present at least a portion of the structured information; and a content presenting module configured to present the at least one recommended content item to at least one user in a user group corresponding to the target service.

In a third aspect of the present disclosure, there is provided an electronic device. The device includes at least one processing unit; and at least one memory coupled to the at least one processing unit and storing instructions executable by the at least one processing unit. The instructions, when executed by the at least one processing unit, cause the device to perform the method of the first aspect.

In a fourth aspect of the present disclosure, there is provided a computer-readable storage medium having stored thereon a computer program that, when executed by a processor, implements the method of the first aspect.

In a fifth aspect of the present disclosure, there is provided a computer program product. The computer program product is tangibly stored in a computer storage medium and includes computer-executable instructions that, when executed by a device, cause the device to perform the method of the first aspect.

It should be understood that the content described in this section is not intended to identify key features or essential features of the embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference signs denote the same or similar elements, where:

FIG. 1 illustrates a schematic diagram of an example environment in which embodiments of the present disclosure can be implemented;

FIG. 2 illustrates a flowchart of a signaling flow for content presentation according to some embodiments of the present disclosure;

FIG. 3A to FIG. 3C illustrate examples of user interfaces for presenting a recommended content item according to some embodiments of the present disclosure;

FIG. 4 illustrates an example of derivation and delivery of a recommended content item according to some embodiments of the present disclosure;

FIG. 5 illustrates an example of derivation and delivery in response to an update of service information according to some embodiments of the present disclosure;

FIG. 6 illustrates a flowchart of a method for content presentation according to some embodiments of the present disclosure;

FIG. 7 illustrates a block diagram of an apparatus for content presentation according to some embodiments of the present disclosure; and

FIG. 8 illustrates a block diagram of an electronic device in which one or more embodiments of the present disclosure can be implemented.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes, and are not intended to limit the scope of protection of the present disclosure.

In the description of the embodiments of the present disclosure, the term “comprise/include” and similar terms should be understood as open inclusion, that is, “comprise/include but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may be included below.

It should be understood that the data involved in the technical solution of the present disclosure (including but not limited to the data itself, the acquisition or use of the data) should follow the requirements of corresponding laws, regulations and related provisions.

It should be understood that before using the technical solutions disclosed in the embodiments of the present disclosure, users should be informed of the type, scope of use, use scenarios, etc. of personal information involved in the present disclosure in an appropriate way according to relevant laws and regulations, and the user's authorization should be obtained.

For example, in response to receiving an active request from a user, prompt information is sent to the user to explicitly prompt the user that the operation requested to be performed will require the acquisition and use of the user's personal information, so that the user can independently choose whether to provide the personal information to software or hardware such as an electronic device, an application, a server or a storage medium that performs the operations of the technical solution of the present disclosure, according to the prompt information.

As an optional but non-limiting implementation, in response to receiving an active request from a user, the prompt information may be sent to the user in the form of, for example, a pop-up window, and the prompt information may be presented in text in the pop-up window. In addition, the pop-up window may also carry a selection control for the user to select “agree” or “disagree” to provide personal information to the electronic device.

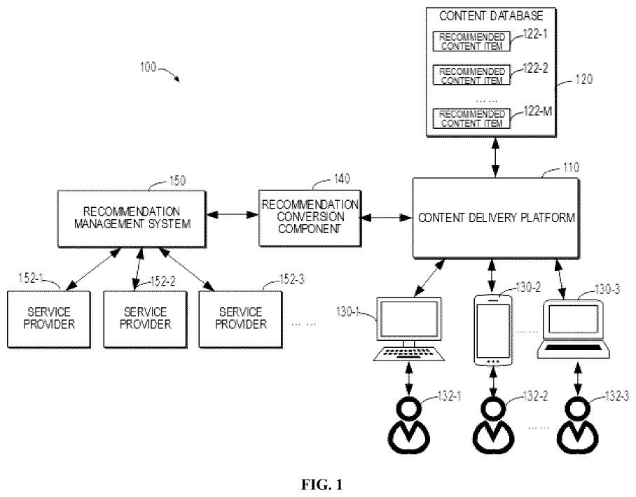

It should be understood that the above process of notifying and acquiring user's authorization is only illustrative, and does not limit the implementations of the present disclosure. Other methods that meet relevant laws and regulations can also be applied to the implementations of the present disclosure.[0026] FIG. 1 illustrates a schematic diagram of an example environment 100 in which embodiments of the present disclosure can be implemented. One or more content providers may use the recommendation management system 150 to manage content to be on the content delivery platform 110. One or more client devices 130-1, 130-2, 130-3, etc. (collectively or individually referred to as the client device 130 for ease of discussion) are associated with the content delivery platform 110 and may, for example, access various contents provided on the content delivery platform 110 based on corresponding users 132-1, 132-2, 132-3, etc. (collectively or individually referred to as users 132 for ease of discussion). As an example, the content delivery platform 110 may be an application, a website, a web page, and other accessible platforms. The client device 130 may be installed with an application to access the content delivery platform 110, or may access the content delivery platform 110 in an appropriate way.

The content delivery platform 110 may be configured to deliver one or more specific recommended content items related to one or more services (for example, provided or presented on the client device 130) to a user group based on a corresponding strategy. The recommended content items to be delivered may include, for example, one or more recommended content items 122-1, 122-2, . . . , 122-M (collectively or individually referred to as recommended content items 122 for ease of discussion) in the content database 120.

Herein, a service may include various objects that can be recommended, examples of which may include applications, physical products/services, virtual products/services, digital contents/physical contents, and so on. Herein, a “recommended content item” refers to content presented in order to recommend a corresponding service. Examples of the recommended content item may include advertisements. Herein, a user group may include one or more user members, such as the users 132. The user members may be any potential consumers of the service, such as users, groups, organizations, entities, and so on.

In some embodiments, the content delivery platform 110 may distribute the corresponding recommended content item 122 to the users 130 based on requests from service providers 152-1, 152-2, 152-3, etc. (collectively or individually referred to as “service providers” 152). In the scenario of advertisement delivery, the service providers are sometimes referred to as advertisers. In some embodiments, the recommended content item to be presented to the specific client device 130 in the content display opportunity (for example, at a specific time and a specific position) of the content delivery platform 110 may be selected based on a bidding result. For example, a bid may be received from a service provider, and the content display opportunity may be allocated to the highest bidder, which means that the corresponding recommended content item may be successfully delivered in competitive delivery. The bid may refer to a cost spent on competing to deliver a certain recommended content item in a certain content display opportunity.

In some embodiments, the service provider may also pay the provider of the content delivery platform 110 based on the presentation of the recommended content item and subsequent conversions. The recommendation conversion component 140 is configured to collect conversion results of the users 132 for the recommended content item. The conversion results for the recommended content item may include viewing, clicking, downloading, paying, adding to shopping cart, etc. of the recommended content item. The specific conversion behavior is related to the recommended service and the serviceprovider.

In some embodiments, the recommended content item 122 may be related to a form capable of collecting information. Such a recommended content item is sometimes referred to as a form advertisement. In this way, by presenting the form, information collection of the form can be performed within the platform. The form advertisement can be used to invite users to subscribe to the service, provide service evaluation, answer follow-up service introduction, and receive information from the service provider, etc. The form submission, that is, the information collected through the form, may also be determined by the recommendation conversion component 140 as the conversion result of the recommended content item.

In the environment 100, the recommendation management system 150 may be configured to deliver recommended content items related to forms. In some embodiments, the form information collected through the delivered form may be stored. The recommendation management system 150 may provide the collected form information to an information demander based on an information request from the service provider 152. In some embodiments, the service providers may also include the service providers who request to deliver the recommended content item, or may be other information demanders.

In the environment 100, the client device 130 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device or any combination thereof, including accessories and peripherals of these devices or any combination thereof. In some embodiments, the client device 130 may also support any type of interface for the user (such as “wearable” circuit, etc.).

In the environment 100, the content delivery platform 110, the recommendation conversion component 140 and/or the recommendation management system 150 may be, for example, various types of computing systems/servers capable of providing computing power, including but not limited to a mainframe, an edge computing node, a computing device in cloud environments, and so on. Although illustrated separately, one or more of the content delivery platform 110, the recommendation conversion component 140 and/or the recommendation management system 150 may be combined.

It should be understood that the components and arrangements in the environment shown in FIG. 1 are only examples, and a computing system suitable for implementing the example embodiments described in the present disclosure may include one or more different components, other components and/or different arrangements.

Generally, depending on the needs of the service provider and the specific content delivery location, the recommended content items to be delivered will have different styles, which will require the service provider to enter different information. At present, the service provider needs to configure different styles of recommended content items. For example, in an advertisement scenario, an advertiser needs to individually design the advertisement content presented on a certain delivery channel. If the advertiser needs to display different advertisement content in different channels and different display opportunities, the advertiser needs to upload different new advertisement content many times. This approach is cumbersome for both content management and content delivery processes.

According to the embodiments of the present disclosure, there is provided an optimized content presentation solution. According to this solution, the service provider provides structured service information related to the target service to be recommended. The structured information may be obtained through a unified and standardized information collection process. Based on the structured service information, a required recommended content item of one or more content styles is automatically generated based on a content derivation rule related to the target service. The generated recommended content item can be presented to the corresponding user. According to the embodiments of the present disclosure, through a unified information collection process, automatic and diversified content generation can be completed. This reduces the delivery operation cost of the service provider, improves efficiency, and optimizes the user experience. In addition, information collection and generation of recommended content items for delivery may be separated from each other, and flexible updates of service information and flexible adjustment of styles of recommended content items may be supported.

Some example embodiments of the present disclosure will be continued to be described below with reference to the drawings.

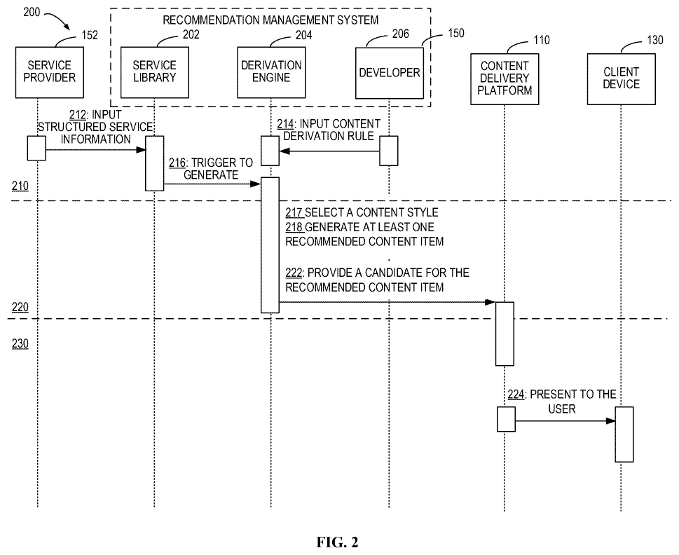

FIG. 2 illustrates a flowchart of a signaling flow 200 for content presentation according to some embodiments of the present disclosure. For the convenience of discussion, the signaling flow 200 is described with reference to FIG. 1. As shown in signaling flow 200, the signaling flow 200 involves the service provider 152, the client device 130, the recommendation management system 150 and the content delivery platform 110. Note that the discussion is only made in conjunction with the recommendation management system 150 for the sake of discussion, but it should be understood that the embodiments of the present disclosure may be implemented in any appropriate device or system.

The recommendation management system 150 may include a service library 202, a derivation engine 204, and also involve a developer 206. Note that here, different components are distinguished by functions only for the purpose of discussion. Different components may be implemented in software, hardware, firmware, and any combination thereof. In practical applications, these components may also be divided in any other appropriate way.

In an information preparation stage 210, the service provider 152 inputs (212) structured service information related to a target service into the service library 202 of the recommendation management system 150. The target service refers to a service that the service provider 152 expects to recommend. The structured service information refers to other information required for generating the recommended content item and/or performing content delivery on the content delivery platform.

In some embodiments, the recommendation management system 150 may provide the service provider 152 with a list of required service information (or additional information) or an information collection page, in which the structured service information that needs to be provided is listed. In some embodiments, the list or page for information collection may include a form of key-value pairs, indicating to the service provider 152 the type of information to be collected, so that the service provider 152 may enter information of a corresponding type. The structured service information related to the target service received from the service provider 152 may be stored in the service library 202.

In addition to the service information, the recommendation management system 150 further acquires the content derivation rule related to the target service. In some embodiments, the content derivation rule related to the target service may be input (214) to the derivation engine 204 by the developer 206 or other operation personnel of the recommendation management system 150. The content derivation rule indicates at least a content style of the one or more recommended content items to be generated for the target service. The content style may indicate a content template of the corresponding recommended content item, which defines various types of information to be filled in. In some examples, the content style may also indicate an appearance style of the corresponding recommended content item, which is not limited in the embodiments of the present disclosure.

In some embodiments, the developer 206 may pre-define the content derivation rules by category. The category here may be a service division performed according to any appropriate criteria and based on characteristics of the provided service. For example, different categories may be divided according to an industry to which the service belongs, according to a service provider or a group of service providers, or categories may also be divided according to other granularity. For different categories, different content derivation rules may be predefined, and each content derivation rule may indicate one or more content styles to be generated. The number and/or content templates of the content styles indicated by different content derivation rules may be different. For example, it may be defined by industry which content style or content styles of recommended content items are to be specifically derived, or it may be defined which content style or content styles of recommended content items are to be specifically derived according to the requirements of the service provider. In this way, the content derivation rule related to the target service may be determined according to the industry in which the target service is located and the corresponding service provider. In some embodiments, the content derivation rule may be customized by the service provider 152 of the target service.

In an automatic derivation stage 220 after the content preparation stage 210, the derivation engine 204 selects (217) at least one content style from a plurality of content styles based on the content derivation rule related to the target service. Based on the structured service information, the derivation engine 204 generates (218) at least one recommended content item having the at least one selected content style, respectively, each recommended content item being used to present at least a portion of the structured information. In some embodiments, after the service provider 152 provides the structured information, the service library 202 may trigger (216) the derivation engine 204 to generate the recommended content item.

As mentioned above, the structured service information of the target service includes a plurality of types of information. Respective one of the content styles here may specify the use of information of at least one type of the plurality of types of the structured service information and a way of organizing the information of the at least one type. In this way, depending on the type of information specified in the corresponding content style, the derivation engine 204 may extract corresponding information from the structured service information, and organize the information in the specified way of organizing to generate the corresponding recommended content item.

The recommended content item is used to be presented to the user to enhance the user's understanding of the target service, thereby helping the user to conveniently acquire the target service as needed. In some embodiments, the recommended content item is sometimes referred to as a conversion carrier or a conversion component of the target service, because by presenting the recommended content item, the service provider is expected to obtain a conversion behavior of the user group to the target service, for example, a user expresses a need to use the target service or a need for further understanding of the target service, and so on. This can help the service provider to obtain more attention from users and obtain conversions of benefits.

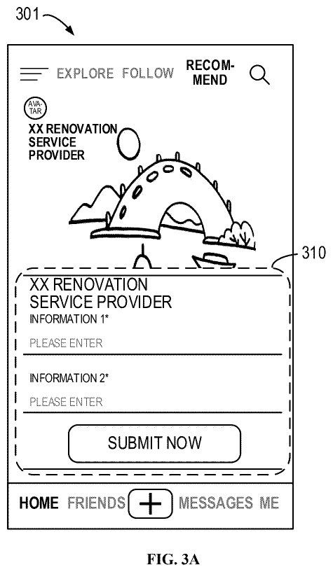

Some examples of the recommended content item may include, but are not limited to, a service details page of the target service, a pop-up window related to the target service, or anchor content presented in association with a multimedia content in a feed. FIG. 3A to FIG. 3C illustrate examples of user interfaces for presenting the recommended content item according to some embodiments of the present disclosure. In the user interface 301 of FIG. 3A, a pop-up window 310 related to the target service (taking “decoration service” as an example) is shown, and the pop-up window 310 may be superimposed and presented on the multimedia content related to the target service, for example. In the user interface 302 of FIG. 3B, a service details page (sometimes also referred to as a “landing page” or “jump page”) related to the target service is shown. The user may access the service details page related to the target service through a series of access paths, where more specific information related to the target service is displayed in a concentrated manner on the page. In the user interface 303 of FIG. 3C, anchor content 330 presented in association with the multimedia content in the feed is shown. The anchor content may be presented to the user with the display of the corresponding multimedia content.

In some embodiments, one or more of the generated and delivered recommended content items may further provide a form for collecting predetermined form information. The design of the form may be determined based on the service provider or the information demander of the target service. The form information may include various information provided by the user that is helpful to provide the target service to the user. For example, the pop-up window 310 in FIG. 3A, the form area 320 in the service details page of FIG. 3B, etc. all provide forms for collecting corresponding information. The client device 130 receives a submission operation of the user 132 on the form, thereby obtaining the form information collected in the form. The client device 130 may submit the collected form information to the server. The server may include, for example, the conversion component 140 and the recommendation management system 150. At the server, the collected form information is at least used to determine the user's intention degree for the target service. In some embodiments, the form includes information input elements for receiving form information.

In some embodiments, the derivation engine 204 may provide a preview of one or more recommended content items to the service provider 152. In this way, the preview of the recommended content item may be generated and presented in response to a request from the service provider 152, or may be presented after the service provider 152 completes the input of the structured information. In this way, the service provider 152 can know the presentation effect of various types of information entered in the form on the user side.

In some embodiments, the plurality of content styles may be determined by a plurality of recommended content items that the recommendation management system 150 supports to generate. For each service provider, the structured information to be collected may include at least a union of information required by the plurality of content styles, although the structured information may further include additional information (for example, information that needs to be collected for other purposes of recommendation management or content delivery). According to the example embodiments of the present disclosure, for the service provider 152, only basic service information needs to be provided, without the need to design the service details page as a whole, which reduces the page design cost. On the other hand, the templated page is also easier to maintain and adapts to updates of the service information morequickly.

After generating the recommended content item, the derivation engine 204 provides (222) a candidate of the generated recommended content item to the content delivery platform 110. In the content presentation stage 230, the content delivery platform 110 presents (224) the at least one recommended content item to at least one user in the user group corresponding to the target service, specifically, on the client device 130 corresponding to the user.

In some embodiments, the content delivery platform 110 may select, based on a content delivery strategy, one or more recommended content items from the at least one recommended content item for delivery to at least one user in the user group. For example, the content delivery platform 110 may select recommended content items to be delivered and determine users to be delivered and content display opportunities (for example, corresponding content delivery channels and display times, etc.) for delivery according to specific scenarios, user needs, etc. Since the recommended content item is automatically generated based on the structured service information, the content delivery platform 110 may have more flexibility to formulate a content delivery strategy and deliver more diversified recommended content items in the content delivery stage, so as to further improve the conversion effect of the user to the targetservice.

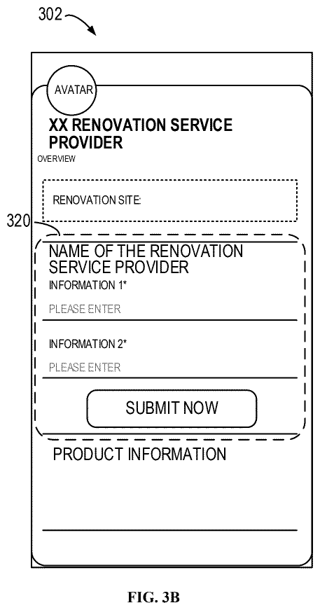

FIG. 4 illustrates an example 400 of derivation and delivery of a recommended content item according to some embodiments of the present disclosure. As shown in the figure, after acquiring the unified structured information 410 of the target service, the derivation engine 204 may automatically generate or derive a plurality of recommended content items, including a service details page 421, a pop-up window 422, anchor content 423 in a feed, and so on. These recommended content items may then be selected and delivered to one or more content delivery channels 431, 432, etc. according to a content delivery strategy of the content delivery platform 110. In the whole derivation and delivery process of the recommended content item, for the service provider, only unified structured service information 410 needs to be provided at once. If a plurality of recommended content items include service information that is reused from each other, the derivation engine 204 can extract from the structured information 410 without requiring the service provider 152 to provide it repeatedly. In addition, the service provider 152 does not need to separately design various appearance styles of the recommended content item, and can conveniently and quickly obtain flexible delivery of the recommended content item.

In some embodiments, the approach of dynamically deriving the recommended content item from the unified structured service information can further support updates of the structured service information and/or updates of the content derivation rule.

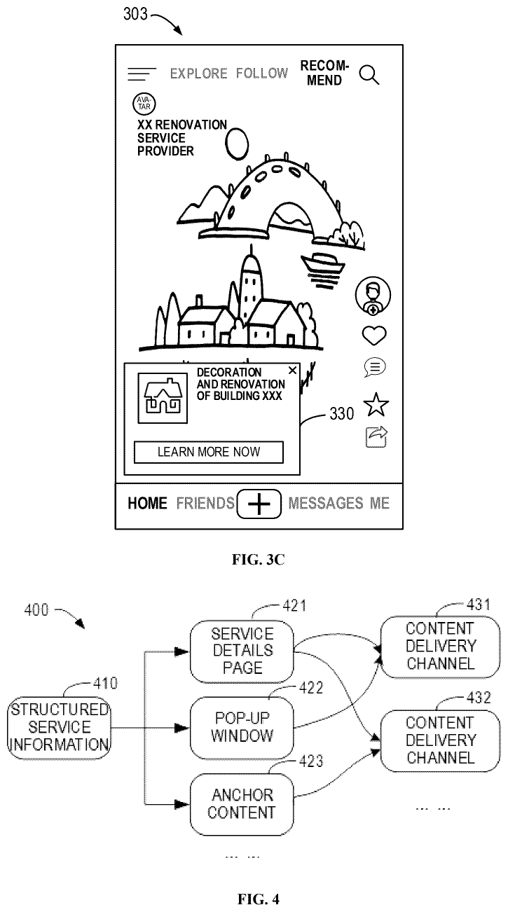

FIG. 5 illustrates an example 500 of derivation and delivery in response to an update of service information according to some embodiments of the present disclosure. In FIG. 5, the service information maintenance system 510 detects an update of the structured information related to the target service in the service library 202. If the service information maintenance system 510 detects an update of at least a portion of information in the structured service information by the service provider 152, the service information state change queue 512 may be triggered. The derivation trigger 514 may trigger the derivation engine 204 to determine whether the at least one recommended content item previously generated is defined to present the at least a portion of information that is updated. For example, assuming that the structured service information includes information parts corresponding to fields A, B, C, and D. If the information part corresponding to the field D is irrelevant to the generated recommended content item, when it is detected that the field D has changed, there is no need to update the recommended content item in conjunction. If it is determined that a certain recommended content item in the at least one recommended content item is defined to present the at least a portion of information, the derivation engine 204 may update the recommended content item. The updated recommended content item is provided to the content delivery platform 110, and the content delivery platform 110 presents it to at least one user in the user group. In this way, it can be ensured that the recommended content item presented to the user can always keep presenting the updated service information.

Specifically, in the derivation engine 204, the state linkage module 524 may be configured to detect the derivation trigger of the derivation trigger 514. The content review module 526 is configured to determine that the structured service information, including the updated structured service information, meets requirements of content compliance and security. The feature extraction module 522 is configured to understand the structured service information, including the semantics of the updated structured service information, to determine whether the updated information part will affect the recommended content item that has been previously generated and delivered.

The derivation engine 204 may determine, based on the content derivation rule 520, references of the generated and delivered recommended content item to the information types in the structured service information, so as to determine whether the updated information part should be updated into the generated recommended content item. The adaptation layer 528 is configured to adapt the updated information part into the generated recommended content item, for example, into various content items such as the service details page 421, the pop-up window 422, and the anchor content 423 related to the target service. The adapted recommended content item may be provided to the content delivery platform 110 for delivery to the user group.

In some embodiments, the derivation engine 204 also supports updating of the content derivation rule related to the target service. For example, after a period of time, the developer 206 or the service provider 152 expects to change the content derivation rule related to the target service, for example, expects to deliver more, fewer or different content styles of recommended content items.

If the derivation engine 205 detects the update of the content derivation rule related to the target service, one or more content styles may be re-determined based on the updated content derivation rule.

If at least another content style for the target service is determined based on the updated content derivation rule, the derivation engine 205 may generate, based on the current structured service information, at least another recommended content item having at least another content style, respectively, and present the at least generated another recommended content item to at least one user in the user group via the content delivery platform 110. Of course, if the updated content derivation rule further instructs to delete one or more content styles previously, the derivation engine 204 may also instruct the content delivery platform 110 to cancel the presentation of the corresponding recommended content item. [0061] In this way, even if the service provider expects to add a new content style (and a recommended content item) after a period of content delivery, the derivation engine 204 may be triggered to generate

more recommended content items by triggering an update of the derivation rule. In this process, the service provider does not even need to perform an additional round of information entry. Of course, in some embodiments, if the derivation engine 204 determines that the information part required by the newly added content style is not completely included in the existing structured service information, the service provider 152 may be requested to supplement this part of information, without supplementing the existing information in the structured service information. This improves the content generation efficiency, significantly reduces the delivery operation cost of the service provider, and optimizes the user experience.

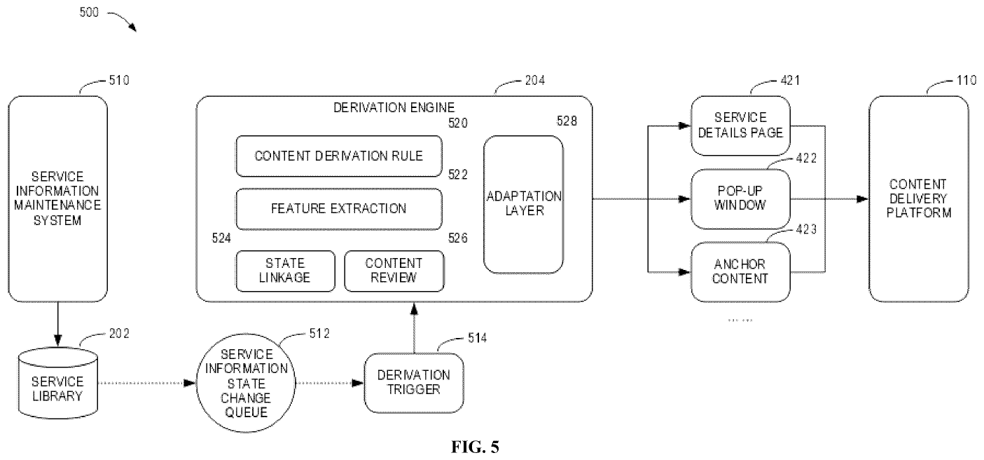

FIG. 6 illustrates a flowchart of a method 600 for content presentation according to some embodiments of the present disclosure. In some embodiments, the method 600 may be implemented in the recommendation management system 150. For purposes of explanation, the method 600 will be described below from the perspective of the recommendation management system 150.

At block 610, the recommendation management system 150 receives, from a service provider, structured service information related to a target service.

At block 620, the recommendation management system 150 selects, based on a content derivation rule related to the target service, at least one content style from a plurality of content styles.

At block 630, the recommendation management system 150 generates, based on the structured service information, at least one recommended content item having the at least one selected content style, respectively, each recommended content item being used to present at least a portion of the structuredinformation.

At block 640, the recommendation management system 150 presents the at least one recommended content item to at least one user in a user group corresponding to the target service.

In some embodiments, the method 600 further includes: detecting an update of the structured service information by the service provider; in response to detecting the update of at least a portion of information in the structured service information, determining whether the at least one recommended content item is defined to present the at least a portion of information; in response to determining that a first recommended content item in the at least one recommended content item is defined to present the at least a portion of information, updating the first recommended content item; and presenting the updated first recommended content item to the at least one user in the user group.

In some embodiments, the structured service information includes a plurality of types of information. In some embodiments, respective one of the plurality of content styles specifies the use of information of at least one type of the plurality of types and a way of organizing the information of the at least one type.

In some embodiments, the method 600 further includes: detecting an update of the content derivation rule related to the target service; if at least another content style for the target service is determined based on the updated content derivation rule, generating, based on the structured service information, at least another recommended content item having the at least another content style, respectively, each recommended content item being used to present at least a portion of the structured information; and presenting the at least another recommended content item to at least one user in the user group.

In some embodiments, presenting the at least one recommended content item to at least one user in the user group corresponding to the target service includes: providing the at least one generated recommended content item to a content delivery platform; and selecting, using the content delivery platform and based on a content delivery strategy, one or more recommended content items from the at least one recommended content item for delivery to the at least one user in the user group.

In some embodiments, the at least one recommended content item includes at least one of: a service details page of the target service, a pop-up window related to the target service, or anchor content presented in association with a multimedia content in a feed.

In some embodiments, one or more of the at least one recommended content item includes a form for collecting predetermined form information.

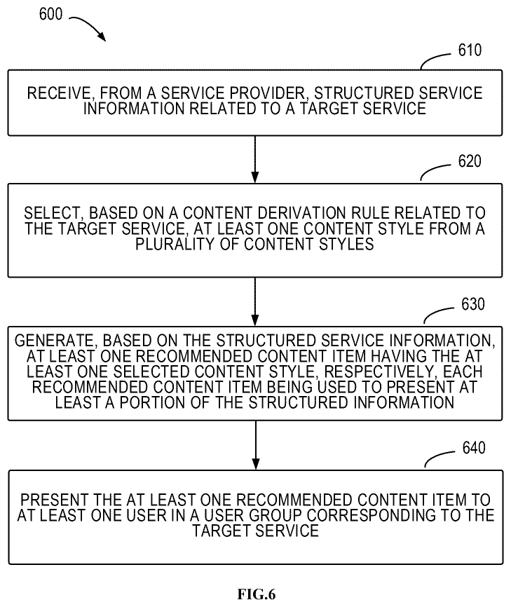

FIG. 7 illustrates a schematic structural block diagram of an apparatus 700 for content presentation according to some embodiments of the present disclosure. The apparatus 700 may be implemented as or included in the recommendation management system 150. The individual modules/components in the apparatus 700 may be implemented in hardware, software, firmware, or any combination thereof.

As shown in the figure, the apparatus 700 includes an information receiving module 710 configured to receive, from a service provider, structured service information related to a target service. The apparatus 700 further includes a style selecting module 720 configured to select, based on a content derivation rule related to the target service, at least one content style from a plurality of content styles. The apparatus 700 further includes a content generating module 730 configured to generate, based on the structured service information, at least one recommended content item having the at least one selected content style, respectively, each recommended content item being used to present at least a portion of the structured information; and a content presenting module 740 configured to present the at least one recommended content item to at least one user in a user group corresponding to the target service. [0075] In some embodiments, the apparatus 700 further includes: an information update detecting module

configured to detect an update of the structured service information by the service provider; a content determining module configured to, in response to detecting the update of at least a portion of information in the structured service information, determine whether the at least one recommended content item is defined to present the at least a portion of information; a content updating module configured to, in response to determining that a first recommended content item in the at least one recommended content item is defined to present the at least a portion of information, update the first recommended content item; and an update presenting module configured to present the updated first recommended content item to the at least one user in the user group.

In some embodiments, the structured service information includes a plurality of types of information. In some embodiments, respective one of the plurality of content styles specifies the use of information of at least one type of the plurality of types and a way of organizing the information of the at least one type.

In some embodiments, the apparatus 700 further includes: a rule update detecting module configured to detect an update of the content derivation rule related to the target service; an additional generating module configured to, if at least another content style for the target service is determined based on the updated content derivation rule, generate, based on the structured service information, at least another recommended content item having the at least another content style, respectively, each recommended content item being used to present at least a portion of the structured information; and an additional presenting module configured to present the at least another recommended content item to at least one user in the user group.

In some embodiments, the content presenting module 740 includes: a platform providing module configured to provide the at least one generated recommended content item to a content delivery platform; and a platform presenting module configured to select, using the content delivery platform and based on a content delivery strategy, one or more recommended content items from the at least one recommended content item for delivery to the at least one user in the user group.

In some embodiments, the at least one recommended content item includes at least one of: a service details page of the target service, a pop-up window related to the target service, or anchor content presented in association with a multimedia content in a feed.

In some embodiments, one or more of the at least one recommended content item includes a form for collecting predetermined form information.

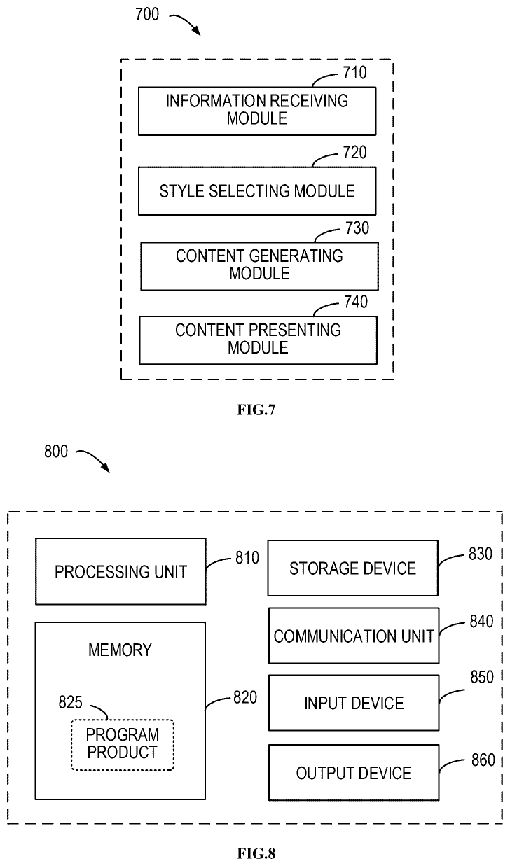

FIG. 8 illustrates a block diagram of an electronic device 800 in which one or more embodiments of the present disclosure can be implemented. It should be understood that the electronic device 800 shown in FIG. 8 is only illustrative, and should not constitute any limitation on the function and scope of the embodiments described herein. The electronic device 800 shown in FIG. 8 may be used to implement the client device 130, or the content delivery platform 110, the recommendation conversion component 140 and/or the recommendation management system 150 (or components therein). The electronic device 800 may also include or be implemented as the apparatus 700 of FIG. 7.

As shown in FIG. 8, the electronic device 800 is in the form of a general-purpose computing device. The components of the electronic device 800 may include, but are not limited to, one or more processors or processing units 810, memory 820, storage devices 830, one or more communication units 840, one or more input devices 850, and one or more output devices 860. The processing unit 810 may be a physical or virtual processor and can perform various processes according to programs stored in the memory 820. In a multi-processor system, multiple processing units execute computer-executable instructions in parallel to improve the parallel processing capability of the electronic device 800.

The electronic device 800 generally includes a plurality of computer storage medium. Such medium may be any available medium accessible by the electronic device 800, including but not limited to volatile and non-volatile medium, removable or non-removable medium. The memory 820 may be a volatile memory (for example, a register, a cache, a random-access memory (RAM)), a non-volatile memory (for example, a read only memory (ROM), an electrically erasable programmable read only memory (EEPROM), a flash memory), or a certain combination thereof. The storage device 830 may be a removable or non-removable medium, and may include a machine-readable medium, such as a flash drive, a magnetic disk, or any other medium, which may be used to store information and/or data (for example, training data for training) and may be accessed within the electronic device 800.

The electronic device 800 may further include additional removable/non-removable, volatile/non-volatile storage medium. Although not shown in FIG. 8, a magnetic disk drive for reading from or writing to a removable, non-volatile disk (for example, a “floppy disk”) and an optical disk drive for reading from or writing to a removable, non-volatile optical disk may be provided. In these cases, each drive may be connected to a bus (not shown) by one or more data medium interfaces. The memory 820 may include a computer program product 825 having one or more program modules, which are configured to perform various methods or actions of various embodiments of the present disclosure.

The communication unit 840 implements communication with other electronic devices through a communication medium. Additionally, functions of components of the electronic device 800 may be implemented in a single computing cluster or multiple computing machines, which can communicate through communication connections. Therefore, the electronic device 800 may use logical connections with one or more other servers, network personal computers (PC) or another network node to operate in a networked environment.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as needed, such as storage devices, display devices, etc., communicate with one or more devices that enable users to interact with the electronic device 800, or communicate with any device (for example, a network card, a modem, etc.) that enables the electronic device 800 to communicate with one or more other electronic devices. Such communication may be performed via an input/output (I/O) interface (not shown).

According to an example implementation of the present disclosure, a computer-readable storage medium is provided, which has computer-executable instructions stored thereon, and the computer-executable instructions are executed by a processor to implement the method described above. According to an example implementation of the present disclosure, a computer program product is further provided, which is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, apparatus, device, and computer program product implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to the processing unit of a general-purpose computer, a special-purpose computer, or other programmable data processing apparatus, so as to produce a machine, so that these instructions, when executed by the processing unit of the computer or other programmable data processing apparatus, produce an apparatus for implementing the functions/actions specified in one or more blocks in the flowcharts and/or block diagrams. These computer-readable program instructions may also be stored in a computer-readable storage medium, and these instructions cause the computer, programmable data processing apparatus and/or other devices to work in a specific way, so that the computer-readable medium storing the instructions includes a product, which includes instructions for implementing various aspects of the functions/actions specified in one or more blocks in the flowcharts and/or block diagrams.

The computer-readable program instructions may be loaded onto a computer, other programmable data processing apparatus, or other devices, such that a series of operational steps are performed on the computer, other programmable data processing apparatus, or other devices to produce a computer-implemented process, such that the instructions executed on the computer, other programmable data processing apparatus, or other devices implement the functions/actions specified in one or more blocks in the flowcharts and/or block diagrams.

The flowcharts and block diagrams in the drawings show possible architectures, functions and operations of the system, method and computer program product according to multiple implementations of the present disclosure. In this regard, each block in the flowcharts or block diagrams may represent a module, a program segment, or a part of an instruction, and the module, program segment, or part of the instruction contains one or more executable instructions for implementing a specified logical function.

In some alternative implementations, the functions marked in the blocks may also occur in a different order than those marked in the drawings. For example, two consecutive blocks may actually be executed substantially in parallel, and they may sometimes be executed in a reverse order, depending on the functions involved. It should also be noted that each block in the block diagrams and/or flowcharts, and combinations of blocks in the block diagrams and/or flowcharts, may be implemented by a dedicated hardware-based system that performs the specified functions or actions, or may be implemented by a combination of dedicated hardware and computer instructions.

Various implementations of the present disclosure have been described above, and the above description is illustrative, not exhaustive, and is not limited to the disclosed implementations. Many modifications and changes will be apparent to those of ordinary skill in the art without departing from the scope and spirit of the described implementations. The selection of terms used herein is intended to best explain the principles, practical applications or improvements of the technologies in the market of the implementations, or to enable other ordinary skilled in the art to understand the implementations disclosed herein.

What is claimed is:

1. A method for content presentation, comprising:
receiving, from a service provider, structured service information related to a target service;
selecting, based on a content derivation rule related to the target service, at least one content style from a plurality of content styles;
generating, based on the structured service information, at least one recommended content item having the at least one selected content style, respectively, each recommended content item being used to present at least a portion of the structured information; and
presenting the at least one recommended content item to at least one user in a user group corresponding to the target service.

2. The method according to claim 1, further comprising:
detecting an update of the structured service information by the service provider;
in response to detecting the update of at least a portion of information in the structured service information, determining whether the at least one recommended content item is defined to present the at least a portion of information;
in response to determining that a first recommended content item in the at least one recommended content item is defined to present the at least a portion of information, updating the first recommended content item; and
presenting the updated first recommended content item to the at least one user in the user group.

3. The method according to claim 1, wherein the structured service information comprises a plurality of types of information, and
wherein respective one of the plurality of content styles specifies the use of information of at least one type of the plurality of types and a way of organizing the information of the at least one type.

4. The method according to claim 1, further comprising:
detecting an update of the content derivation rule related to the target service;
in accordance with a determination that at least another content style for the target service is determined based on the updated content derivation rule, generating, based on the structured service information, at least another recommended content item having the at least another content style, respectively, each recommended content item being used to present at least a portion of the structured information; and
presenting the at least another recommended content item to at least one user in the user group.

5. The method according to claim 1, wherein presenting the at least one recommended content item to the at least one user in the user group corresponding to the target service comprises:
providing the at least one generated recommended content item to a content delivery platform; and
selecting, using the content delivery platform and based on a content delivery strategy, one or more recommended content items from the at least one recommended content item for delivery to the at least one user in the user group.

6. The method according to claim 1, wherein the at least one recommended content item comprises at least one of: a service details page of the target service, a pop-up window related to the target service, or anchor content presented in association with a multimedia content in a feed.

7. The method according to claim 1, wherein one or more of the at least one recommended content item comprise a form for collecting predetermined form information.

8. The method according to claim 1, wherein the structured service information related to the target service received from the service provider is stored in a service library.

9. The method according to claim 1, wherein the target service comprises a service that the service provider expects to recommend.

10. The method according to claim 1, wherein the structured service information comprises other information required for generating the at least one recommended content item and/or delivering the at least one recommended content on the content delivery platform.

11. An electronic device, comprising:
at least one processing unit; and
at least one memory coupled to the at least one processing unit and storing instructions executable by the at least one processing unit, the instructions, when executed by the at least one processing unit, causing the device to perform acts comprising:
receiving, from a service provider, structured service information related to a target service;
selecting, based on a content derivation rule related to the target service, at least one content style from a plurality of content styles;
generating, based on the structured service information, at least one recommended content item having the at least one selected content style, respectively, each recommended content item being used to present at least a portion of the structured information; and
presenting the at least one recommended content item to at least one user in a user group corresponding to the target service.

12. The electronic device, according to claim 11, the acts further comprise:
detecting an update of the structured service information by the service provider;
in response to detecting the update of at least a portion of information in the structured service information, determining whether the at least one recommended content item is defined to present the at least a portion of information;
in response to determining that a first recommended content item in the at least one recommended content item is defined to present the at least a portion of information, updating the first recommended content item; and
presenting the updated first recommended content item to the at least one user in the user group.

13. The electronic device according to claim 11, wherein the structured service information comprises a plurality of types of information, and
wherein respective one of the plurality of content styles specifies the use of information of at least one type of the plurality of types and a way of organizing the information of the at least one type.

14. The electronic device according to claim 11, the acts further comprise:
detecting an update of the content derivation rule related to the target service;
in accordance with a determination that at least another content style for the target service is determined based on the updated content derivation rule, generating, based on the structured service information, at least another recommended content item having the at least another content style, respectively, each recommended content item being used to present at least a portion of the structured information; and
presenting the at least another recommended content item to at least one user in the user group.

15. The electronic device according to claim 11, wherein presenting the at least one recommended content item to the at least one user in the user group corresponding to the target service comprises:
providing the at least one generated recommended content item to a content delivery platform; and
selecting, using the content delivery platform and based on a content delivery strategy, one or more recommended content items from the at least one recommended content item for delivery to the at least one user in the user group.

16. The electronic device according to claim 11, wherein the at least one recommended content item comprises at least one of: a service details page of the target service, a pop-up window related to the target service, or anchor content presented in association with a multimedia content in a feed.

17. The electronic device according to claim 11, wherein one or more of the at least one recommended content item comprise a form for collecting predetermined form information.

18. The electronic device according to claim 11, The electronic device according to claim 1, wherein one or more of the at least one recommended content item comprise a form for collecting predetermined form information.

19. A non-transitory computer-readable storage medium having stored thereon a computer program that, when executed by a processor, implements the acts comprising:
receiving, from a service provider, structured service information related to a target service;
selecting, based on a content derivation rule related to the target service, at least one content style from a plurality of content styles;
generating, based on the structured service information, at least one recommended content item having the at least one selected content style, respectively, each recommended content item being used to present at least a portion of the structured information; and
presenting the at least one recommended content item to at least one user in a user group corresponding to the target service.
